(19) United States
(12) Patent Application Publication
(10) Pub. No.: US 2026/0057180 A1
(43) Pub. Date: Feb. 26, 2026

(54) INTENT-AWARE AND CONTEXT-AWARE TERMINOLOGY ADJUSTMENT

(71) Applicant: INTERNATIONAL BUSINESS MACHINES CORPORATION, ARMONK, NY (US)

(72) Inventors: Jessica Nahulan, Markham (CA); Laura Snider, Woodbridge (CA); Jeremy Ray Fox, Georgetown, TX (US); Allen Vi Cuong Chan, Markham (CA)

(21) Appl. No.: 18/811,858

(22) Filed: Aug. 22, 2024

(51) Int. Cl. G06F 40/30; G06F 40/253; G06F 40/284

(52) U.S. Cl. CPC G06F 40/30; G06F 40/253; G06F 40/284

(57) ABSTRACT

An approach is provided for recommending terminology adjustments. Textual data is collected from multiple sources and analyzed to determine client-specific, organization-specific, and industry-specific terminologies, and contexts and intents associated with respective terms included in the terminologies. A term is identified that is non-compliant with the client-specific, organization-specific, and industry-specific terminologies and the contexts and the intents by analyzing an intended communication that is directed to a client and includes the term. Another term is determined to be an alternative term to the identified term, and is compliant with the client-specific, organization-specific, and industry-specific terminologies and the contexts and the intents. The identified term is flagged in real-time in the intended communication to indicate the alternative term is a recommended replacement for the identified term in the intended communication.

### BACKGROUND

The present invention relates to terminology adjustment, and more particularly to adjusting terminology when communicating with a client to comply with terminology commonly used by a client, a client's organization, and within a client's industry.

### SUMMARY

In one embodiment, the present invention provides a computer-implemented method. The method includes collecting and analyzing textual data from multiple sources to determine client-specific, organization-specific, and industry-specific terminologies, and contexts and intents associated with respective terms included in the terminologies. The method further includes identifying a term that is non-compliant with the client-specific, organization-specific, and industry-specific terminologies and the contexts and the intents by analyzing an intended communication that is directed to a client and includes the term. The method further includes determining, by a processor set, that another term is an alternative term to the identified term, and is compliant with the client-specific, organization-specific, and industry-specific terminologies and the contexts and the intents. The method further includes flagging the identified term in real-time in the intended communication to indicate the alternative term is a recommended replacement for the identified term in the intended communication.

A computer system and a computer program product corresponding to the above-summarized computer-implemented method are also described herein.

### BRIEF DESCRIPTION OF THE DRAWINGS

FIG. 1 is a block diagram of a system for recommending a terminology adjustment, in accordance with embodiments of the present invention.

FIG. 2 is a block diagram of modules included in code included in the system of FIG. 1, in accordance with embodiments of the present invention.

FIG. 3 is a flowchart of a process of recommending a terminology adjustment, where operations of the flowchart are performed by modules in FIG. 2, in accordance with embodiments of the present invention.

FIG. 4 is a block diagram of components that perform the operations in the flowchart of FIG. 3, in accordance with embodiments of the present invention.

FIG. 5 is a flowchart of process steps performed by a language analysis engine, which is included in the components of FIG. 4, in accordance with embodiments of the present invention.

FIG. 6 is a flowchart of process steps performed by a compliance and recommendation engine, which is included in the components of FIG. 4, in accordance with embodiments of the present invention.

FIG. 7 is a flowchart of process steps performed by a user interaction analyzer, which is included in the components of FIG. 4, in accordance with embodiments of the present invention.

### DETAILED DESCRIPTION

### Overview

People use different terminology in different industries. When people in an organization communicate with a client, but do not use the same terms the client uses, the client perceives the organization as not understanding the business of the client. When the terms an organization uses do not match the audience for a marketing campaign, in a user interface, or in documentation, prospective clients may decide against (i) purchasing a product, (ii) continuing to use a product, or (iii) ever working with the organization again. This mismatch of terminology usage leads to a risk of disconnecting from a client or prospective client with whom an organization is trying to connect, which can negatively affect the brand of the organization and lead to lost sales. In traditional interactions with a client during a commerce-oriented transaction, in a user interface, and in documentation, at least some terminology used is not adjusted to the preferences of the client and is not consistent with the terminology of (i) the industry in which the client works and (ii) the particular organization for which the client works.

Embodiments of the present invention address the aforementioned unique challenges by providing a text analysis and recommendation tool that modifies and streamlines industry-specific communications by adjusting the user interface, product documentation, product marketing, and support language to match terms specific to a client and to a particular industry of the client, thereby minimizing user confusion, encouraging seamless interaction, and obtaining and retaining connections with clients and users. Embodiments of the present invention analyze and adjust text in real-time, where the analysis is based on considerations of industry standards, audience preferences, geo-cultural and region indicators, trending terminology, and the audience's own terminology preferences. Embodiments of the present invention ensure that a communication with an audience matches the expectations, technology exposure, and language choices of the audience. In one embodiment, in response to detecting terminology in the communication that does not comply with terminology specific to a client, the client's organization, and the client's industry standards, the user of the text analysis and recommendation tool is prompted with a terminology recommendation to change the terminology currently in the communication. The text analysis and recommendation tool disclosed herein enhances communication and comprehension efficiency, the perception of the brand of the organization whose employees use the tool, and user satisfaction across various industries.

In one embodiment, the text analysis and recommendation tool disclosed herein provides a method for industry-specific language and client-specific language detection and synchronization, which ensures that the language in a communication is familiar and easily understood.

In one embodiment, the text analysis and recommendation tool disclosed herein provides a method for real-time text intent analysis and contextual recommendations to understand the context, intent, and audience of a communication.

In one embodiment, the text analysis and recommendation tool disclosed herein provides a method for compliance checks, unapproved knowledge exposure detection, and supervisory controls to add a layer of oversight and standards enforcement.

Input to the text analysis and recommendation tool disclose herein includes (i) user/customer profiles, roles, preferences, and industry profiles; (ii) organizational and region and global policies and guidelines; (iii) reputable and trending industry-related documentations, publications, and written literature; (iv) articles on language conventions and events of interest, including measures of trending or down-trending; (v) product and competitor information and documentation; (vi) internal and external terms of industry technologies and organizations; (vii) business strategies and historical data about past conversations; and (viii) terminology usage information from enterprise databases.

Output from the text analysis and recommendation tool disclosed herein includes (i) a trained model capable of classifying conversations and providing preferred text recommendations based on the audience and context of the communication; (ii) context-aware and intent-aware text recommendations (e.g., text recommendations for persuasive and marketing language differ from text recommendations for language used in support documentation for a product); (iii) personalized and adaptive text recommendations that learn from introduced and exposed subject matter, terminology, and knowledge-sharing during past interactions; and (iv) authority and compliance approval integrations with a feedback loop for approved language and subject matter with context.

In one embodiment, the terminology adjustment disclosed herein enhances a generative artificial intelligence (AI) virtual agent and is applied to digital-agent communications. The terminology adjustment disclosed herein allows the virtual agent to comprehend industry-specific and customer-specific terminologies and interpret user queries with greater precision, especially in specialized fields. The enhanced understanding of terminologies facilitates more accurate and contextually relevant responses, leading to improved and personalized user experiences and more effective interactions. Furthermore, the techniques disclosed herein allow the aforementioned virtual agent to tailor its responses based on the unique language preferences of individual users and their contextual expectations in the industry. This personalization facilitates more engaging and relevant conversations because the virtual agent seamlessly adapts its language to suit the context and audience (e.g., to suit experts in a particular field or general users).

In traditional approaches to communication with clients, user research regarding terminology is often missed during the product design and project marketing stages of product development, which hinders the building of credibility with the client. The techniques disclosed herein allow an organization to better harvest users' terminology and employ that terminology in the organization's communications with clients and prospective clients. By using the terminology that a client uses, the organization emphasizes that the organization understands the business of the client and more successfully captures and retains the interest of the client.

Organizations often lack the end-to-end consistency regarding the terminology used when conversing with clients and across products sold as part of a suite. For example, there can be a disconnect between the terminology used during pre-sales and marketing and the terminology used in the product and its documentation, which causes customer frustration and distrust, and negatively affects the organization's reputation. The techniques disclosed herein ensure collaboration and terminology congruence throughout the entire commerce transaction.

In one embodiment, the system disclosed herein determines a role, an industry, an organization, a level of experience, and preferences of a client and determines a preferred style of communication with the client based on the role, industry, organization, level of experience, and preferences of the client. The system disclosed herein analyzes an intended communication with the client to identify a current style of communication used in the intended communication, and determines whether the current style of communication matches the preferred style of communication. In response to determining that the current style of communication does not match the preferred style of communication, the system disclosed herein generates a recommendation to change the style of the intended communication to the preferred style of communication. A communication style recommendation can provide, for example, the same response in different patterns to different users (e.g., point form versus paragraph or summarized versus detailed). Additionally, terminology and communication styles and preferences can be influenced by the user's role within the organization.

In one embodiment, the system disclosed herein provides recommended terminology adjustments that tailor communications to different levels of experience of people working in the field of software development. For example, the system can provide a first set of recommendations for terminology adjustments in a communication to a new hire in a software development team, while providing a different, second set of recommendations for terminology adjustments in a communication to a more experienced software developer in the same software development team. These different sets of recommended terminology adjustments provide an overall improvement in effectiveness of communication with the software development team, which can lead to improvements in efficiency and speed of software development.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

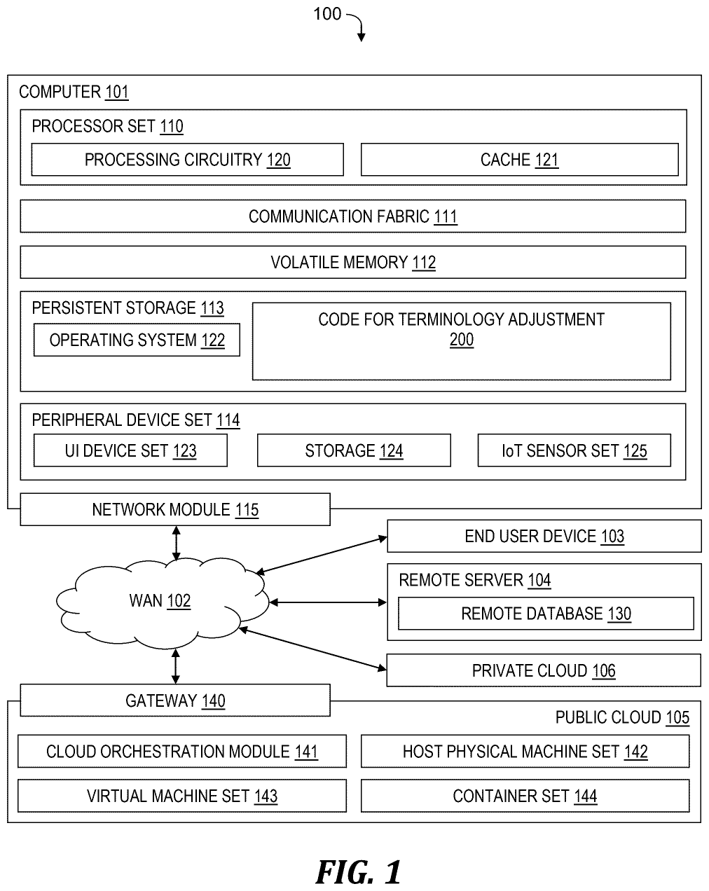

FIG. 1 is a block diagram of a system for recommending a terminology adjustment, in accordance with embodiments of the present invention. Computing environment 100 contains an example of an environment for the execution of at least some of the computer code involved in performing the inventive methods, such as code 200 for terminology adjustment. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for Terminology Adjustment

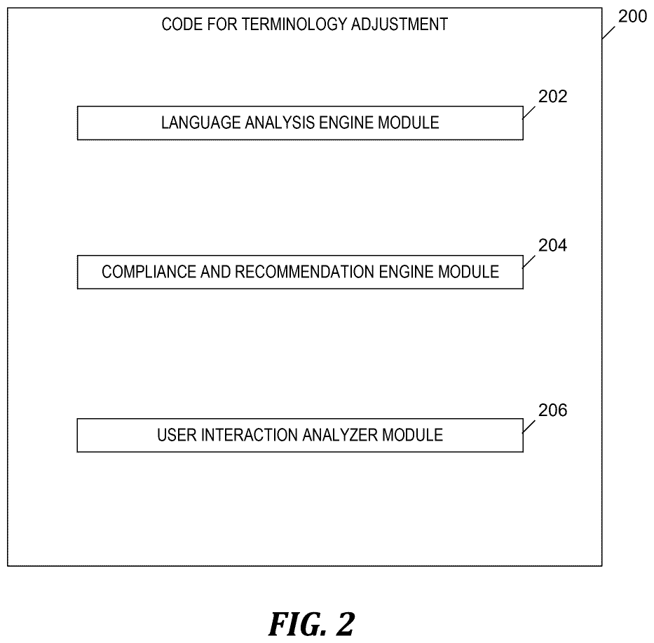

FIG. 2 is a block diagram of modules included in code 200 included in the system of FIG. 1, in accordance with embodiments of the present invention. Code 200 includes a language analysis engine (LAE) module 202, a compliance and recommendation engine (CRE) module 204, and a user interaction analyzer (UIA) module 206.

LAE module 202 is configured to employ natural language processing (NLP) and machine learning models to analyze text to obtain terminologies, and contexts and intents associated with respective terms included in the terminologies. The obtained terminologies include client-specific terminologies, organization-specific terminologies, and industry-specific terminologies. For example, for a given client who belongs to a given organization and works in a given industry, the terminologies include a first terminology specific to the given client, a second terminology specific to the given organization, and a third terminology specific to the given industry. LAE module 202 is further configured to evaluate user and customer profiles associated with clients to determine a given enterprise technology to which a given client is exposed, industry standards associated with the given client, and contextual nuances associated with the given client, to ensure language congruence. LAE module 202 is further configured to send analyzed data to the CRE module 204 for further evaluation.

CRE module 204 is configured to cross-reference the analyzed text with organizational policies, industry guidelines, client-specific, organization-specific and industry-specific terminologies, and language standards. CRE module 204 is further configured to flag non-compliant terms (i.e., non-compliant with the aforementioned policies, guidelines and terminologies) and generate terminology adjustment recommendations that are contextually compliant, compliant with the organizational policies, industry guidelines and language standards, and compliant with client-specific, organization-specific, and industry-specific terminologies. CRE module 204 is further configured to receive as input the output from LAE module 202 for compliance checks (i.e., cross-referencing a term in an intended communication against organizational policies, proprietary content, global standards, and industry-specific guidelines for compliance with language appropriateness and regulatory standards). Hereinafter, proprietary content is also referred to as internal terminology and regulatory standards are also referred to as regulatory compliance policies. CRE module 204 is further configured to provide the UIA module 206 with recommendations for alternative terms that satisfy the aforementioned compliance checks and comply with the client-specific, organization-specific, and industry-specific terminologies. Hereinafter, an alternative term is also referred to as a replacement term or a substitute term.

UIA module 206 is configured to integrate user interaction history (i.e., historical data regarding terms used in previous communications with clients) and client preferences to personalize an intended communication with a client. UIA module 206 is further configured to adapt terminology in an intended communication based on historical data, user profiles of clients, and the context of the intended communication. UIA module 206 is further configured to learn of pre-approved subject matter and introduced or explained and established terminology. UIA module 206 is further configured to use the output from the LAE module 202 and the output from the CRE module 204 to generate terminology adjustment recommendations for an intended communication that are personalized to the client to which the communication is directed, ensuring the usage of terminology that is preferred by the client, while remaining compliant in accordance with the output of the CRE module 204.

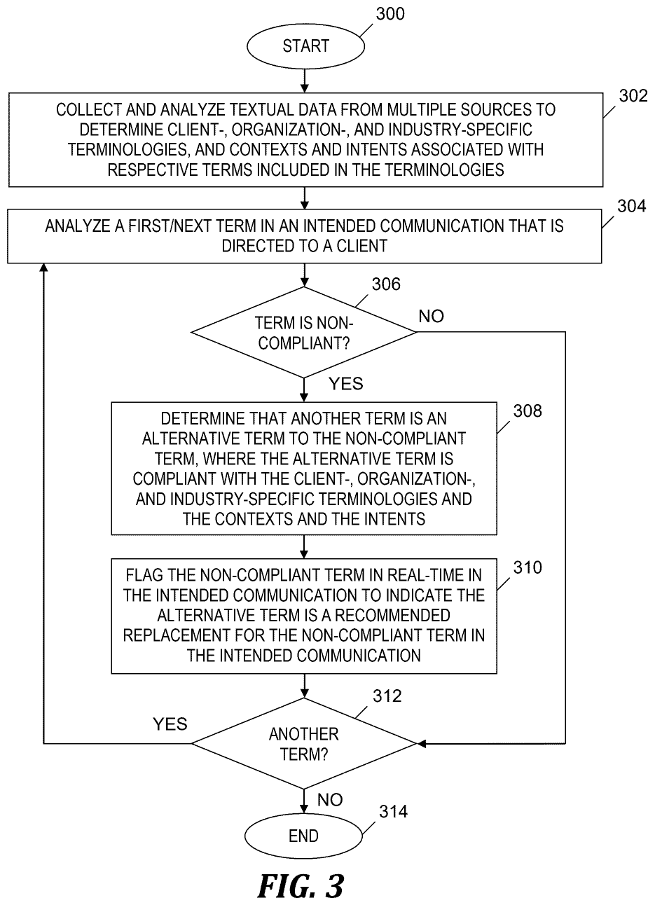

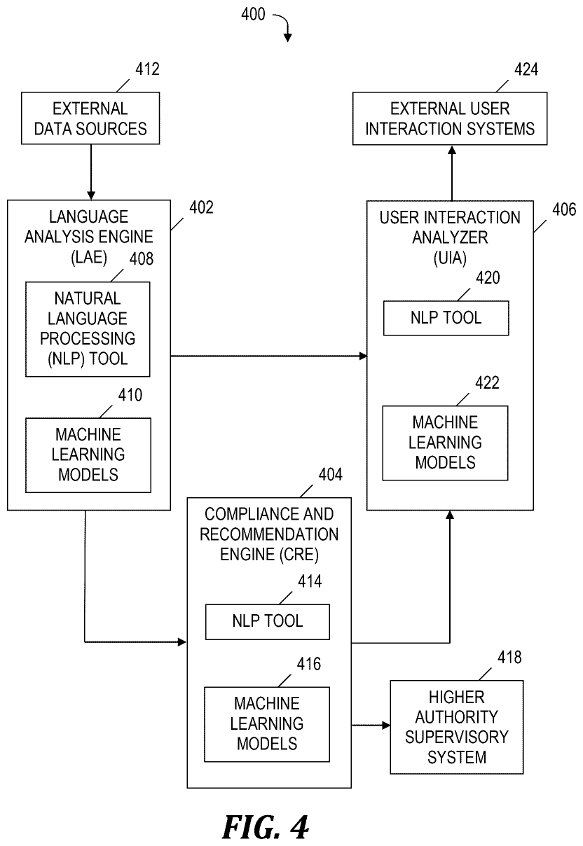

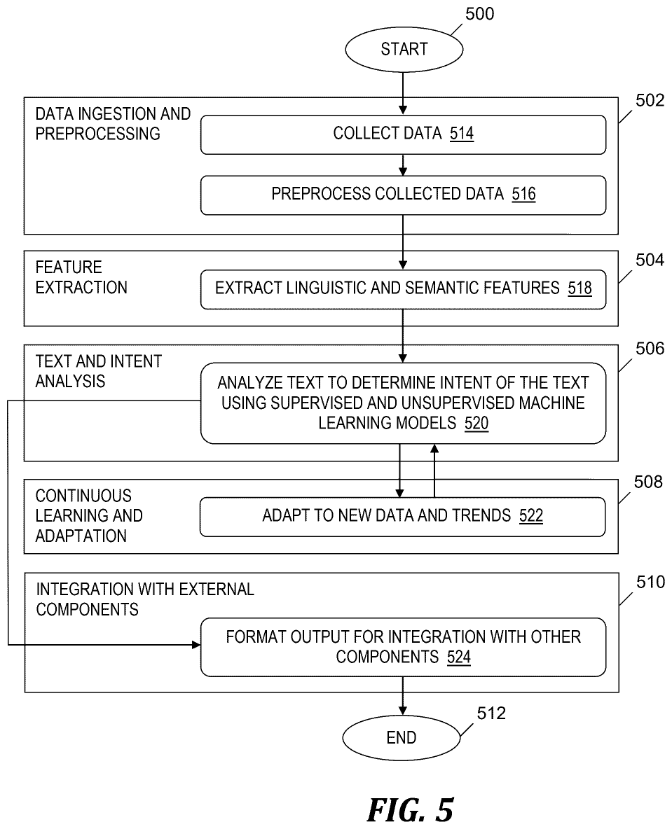

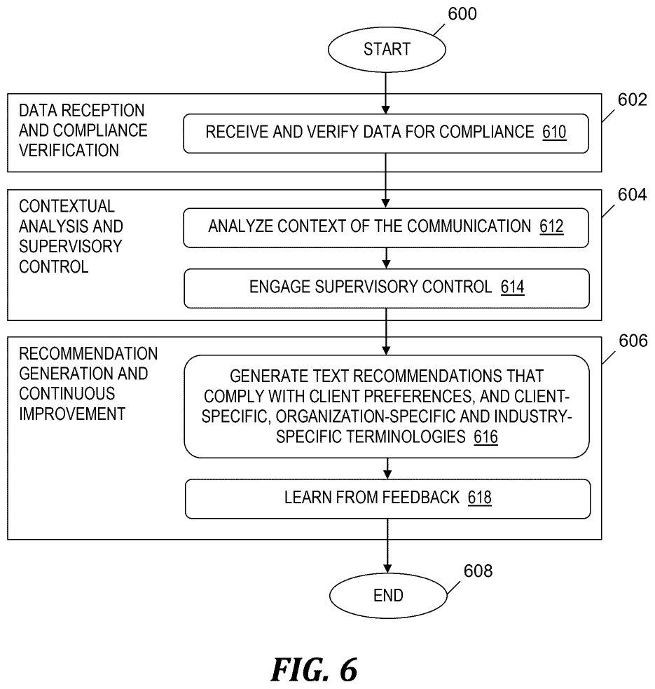

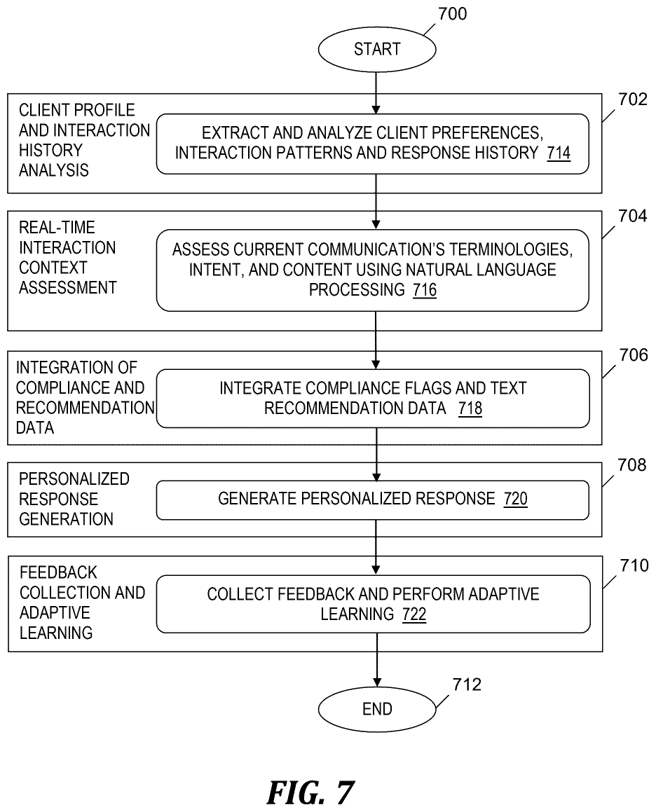

The functionality of the modules included in code 200 is described in more detail in the discussions presented below relative to FIG. 3, FIG. 4, FIG. 5, FIG. 6, and FIG. 7.

FIG. 3 is a flowchart of a process of recommending a terminology adjustment, where operations of the flowchart are performed by modules in FIG. 2, in accordance with embodiments of the present invention. The process of FIG. 3 begins at a start node 300. In step 302, LAE module 202 collects and analyzes textual data from multiple sources to determine client-specific, organization-specific, and industry-specific terminologies, and contexts and intents associated with respective terms in the terminologies.

In step 304, CRE module 204 analyzes, in real-time, a term included in an intended communication that is directed to a client to determine whether the term is compliant with the client-specific, organization-specific, and industry-specific terminologies, and the contexts and the intents analyzed in step 302.

In step 306, CRE module 204 determines whether the term analyzed in step 304 is non-compliant (i.e., the term is not compliant with the client-specific, organization-specific, and industry-specific terminologies, or not compliant with the contexts or the intents analyzed in step 302). If CRE module 204 determines in step 306 that the term is non-compliant, then the Yes branch of step 306 is followed and step 308 is performed.

In step 308, CRE module 204 determines that another term is an alternative term to the non-compliant term, and determines that the alternative term is compliant with the client-specific, organization-specific, and industry-specific terminologies, and the contents and the intents analyzed in step 302

In step 310, CRE module 204 flags the non-compliant term in the intended communication to indicate that the alternative term is a recommended terminology adjustment (i.e., recommended replacement term) for the non-compliant term in the intended communication. Steps 304, 306, 308, and 310 are performed in real-time, which means that the steps are performed during a time period in which the intended communication is being generated by a user utilizing a computer system, but before the generation of the intended communication is finished by the user.

In step 312, CRE module 204 determines whether there is another term in the intended communication that remains to be processed by the aforementioned steps starting at step 304. If CRE module 204 determines that there is another term to be processed, then the process of FIG. 3 loops back to step 304, in which the next term in the intended communication is analyzed for compliance with the client-specific, organization-specific, and industry-specific terminologies, and the contents and the intents analyzed in step 302.

Returning to step 312, if CRE module 204 determines that there is not another term in the intended communication that remains to be processed (i.e., the user is finished generating the intended communication), then the No branch of step 312 is followed and the process of FIG. 3 ends at an end node 314.

Returning to step 306, if CRE module determines that the term analyzed in step 304 is compliant with the client-specific, organization-specific, or industry-specific terminologies, and is compliant with the contexts and the intents analyzed in step 302, then the No branch of step 306 is followed and the process of FIG. 3 continues with step 312, as described above.

FIG. 4 is a block diagram of components that perform the operations in the flowchart of FIG. 3, in accordance with embodiments of the present invention. System 400 includes a language analysis engine (LAE) 402, a compliance and recommendation engine (CRE) 404, and a user interaction analyzer (UIA) 406. Execution of LAE module 202, CRE module 204, and UIA module 206 provides the functionality of LAE 402, CRE 404, and UIA 406, respectively.

LAE 402 includes an NLP tool 408 and machine learning models 410. LAE 402 ingests raw textual data from multiple external data sources 412. LAE 402 preprocesses the textual data. After preprocessing, LAE 402 extracts relevant features from the preprocessed textual data. LAE 402 uses NLP tool 408 for the aforementioned preprocessing and feature extraction.

LAE 402 analyzes terminology in the preprocessed textual data to determine intent(s) and context(s) of the textual data. Machine learning models 410 includes supervised machine learning models and unsupervised machine learning models. LAE 402 uses the supervised machine learning models to identify (i.e., classify) specific terminologies and intents in the textual data. LAE 402 uses the unsupervised machine learning models to identify patterns in the textual data and to determine underlying themes or subjects in the textual data.

LAE 402 continuously learns and adapts based on receipt and analysis of new data. LAE 402 formats the analyzed textual data and makes the formatted data available for integration with CRE 404 and to provide data for personalization by UIA 406.

Details of the operations performed by LAE 402 are presented below in the discussion of FIG. 5.

CRE 404 includes an NLP tool 414 and machine learning models 416. CRE 404 receives processed textual data from LAE 402 and parses the received data to identify key elements, including intents, contexts, and client-specific, organization-specific, and industry-specific terminologies. CRE 404 performs compliance verification on the textual data. CRE 404 uses machine learning models 416 for the analysis of the textual data and the compliance verification.

CRE 404 also performs contextual analysis and initiates supervisory control CRE 404 analyzes the context and intent of an intended communication directed to a client by using NLP tool 414 and machine learning techniques that employ machine learning models 416. For textual data flagged as non-compliant (i.e., not compliant with organizational policies, policies about proprietary content, global standards, and industry-specific guidelines regarding language appropriateness and regulatory standards), CRE 404 sends the flagged textual data to a higher authority supervisory system 418 for manual review and approval of the textual data by a higher authority.

Furthermore, CRE 404 generates recommendations for terminology adjustment by recommending alternative terms for terms in the intended communication, where the alternative terms comply with preferences of the client and client-specific, organization-specific, and industry-specific terminologies. CRE 404 sends the generated recommendations to UIA 406 for further processing relative to personalization of the intended communication.

CRE 404 also incorporates a feedback loop using actual communications with clients and supervisory decisions via higher authority supervisory system 418 to continuously refine the compliance verification, contextual analysis, and recommendation generation performed by CRE 404.

Details of the operations performed by CRE 404 are presented below in the discussion of FIG. 6.

UIA 406 includes an NLP tool 420 and machine learning models 422. UIA 406 analyzes information in a user profile of the client and historical data about interactions with the client. UIA 406 also assesses the context of the intended communication in real-time by interpreting the intended communication's terminologies, intentions, and context using NLP tool 420.

Furthermore, UIA 406 integrates the compliance flags and recommendation data from CRE 404 to ensure that the intended communication complies with the preferences of the client and the historical data about the interactions, while also complying with organizational and industry standards, and avoiding disclosure of unauthorized proprietary information.

UIA 406 generates personalized responses and personalized adjustments to terminology in the intended communication by using the analyzed user profile and historical interaction data and the integrated recommendations from CRE 404. UIA 406 uses machine learning models 422 to generate the personalized responses and personalized terminology adjustments. UIA 406 sends the personalized responses and personalized adjustments to the terminology in the intended communication to external user interaction systems 424.

After the adjusted and personalized communication is sent to the client and after the client responds to the communication, UIA 406 collects feedback from the client's response and uses the feedback for adaptive learning.

Details of the operations performed by UIA 406 are presented below in the discussion of FIG. 7.

FIG. 5 is a flowchart of process steps performed by language analysis engine 402, which is included in the components of FIG. 4, in accordance with embodiments of the present invention. The process of FIG. 5 begins at a start node 500 and is followed by data ingestion and preprocessing in step 502, feature extraction in step 504, text and intent analysis in step 506, continuous learning and adaptation in step 508, and integration with external components in step 510. Following step 510, the process of FIG. 5 ends at an end node 512.

In sub-step 514, which is included in step 502, LAE 402 collects or ingests textual data from external data sources 412. In one embodiment, the external data sources 412 include user and customer profiles, industry-related documents, documents about enterprise technologies, and historical conversation data. In sub-step 516, which is included in step 502, LAE 402 preprocesses the collected textual data. In one embodiment, the preprocessing includes tokenization, normalization (e.g., lowercasing), and the removal of irrelevant characters or words (i.e., characters or words that are irrelevant to an analysis by machine learning models). The preprocessing step cleans and standardizes the collected textual data, thereby making the data suitable for analysis by machine learning models 410.

In sub-step 518, which is included in step 504, LAE 402 extracts linguistic and semantic features from the preprocessed textual data. In one embodiment, the linguistic features include n-grams, part-of-speech tags, and syntactic dependencies, and the semantic features include word embeddings. The linguistic and semantic features are important for determining the context and the intent of the text. Extraction of both syntactic and semantic features ensures a comprehensive analysis of the text. In one embodiment, LAE 402 uses pre-trained models (e.g., Word2Vec or Bidirectional Encoder Representations from Transformers (BERT) language model) to extract semantic features in sub-step 518. In one embodiment, LAE 402 uses natural language processing application programming interfaces (APIs) for integration of NLP toolkits (e.g., Natural Language Toolkit (NLTK)) for the preprocessing in sub-step 516 and the feature extraction in sub-step 518.

In sub-step 520, which is included in step 506, LAE 402 analyzes the terminology to determine the intents and contexts of the text, which is achieved by using a combination of supervised and unsupervised machine learning models (i.e., machine learning models 410). LAE 402 uses the supervised machine learning models, which are trained on labeled data sets, to identify (i.e., classify) specific terminologies and intents. LAE 402 uses the unsupervised machine learning models (e.g., topic modeling) to determine underlying themes or subjects in the text. LAE 402, CRE 404, and UIA 406 use the results of the terminology analysis and the intent analysis to match an intended communication with preferences of a client and industry standards.

In one embodiment, LAE 402 employs supervised learning, which uses algorithms such as Support Vector Machines (SVM), Naïve Bayes, and neural networks for classification of terminologies and intents. In one embodiment, LAE 402 employs unsupervised learning, which uses algorithms, such as latent Dirichlet allocation (LDA) for topic modeling and clustering algorithms to identify patterns in text data.

In sub-step 522, which is included in step 508, LAE 402 continuously learns and adapts to new data, which includes retraining machine learning models 410 with updated data and user feedback to improve accuracy and relevance of subsequent terminology adjustments. In one embodiment, LAE 402 uses online learning or incremental learning to enable system 400 to adapt quickly to new trends, terminologies, and user preferences without the need for full retraining of machine learning models 410.

In sub-step 524, which is included in step 510, LAE 402 formats the analyzed textual data and makes the formatted data available for integration with other system components, such as CRE 404 and UIA 406. Sub-step 524 ensures that the output of LAE 402 is in a suitable format and includes all the necessary metadata for further processing by CRE 404 and UIA 406. Furthermore, sub-step 524 facilitates maintaining a seamless workflow across different components of system 400. In one embodiment, LAE 402 adheres to RESTful API standards for seamless integration with other components of system 400. RESTful refers to complying with representational state transfer (REST) architectural constraints.

In one embodiment, LAE 402 uses frameworks such as the APACHE® KAFKA® stream-processing platform or the RABBITMQ® architecture to handle real-time data streams. APACHE and KAFKA are registered trademarks of The Apache Software Foundation located in Wilmington, Delaware. RABBITMQ is a registered trademark of Pivotal Software, Inc. located in San Francisco, California.

In one embodiment, LAE 402 ensures compliance with data privacy and security standards, such as GDPR and HIPAA for handling sensitive user data.

FIG. 6 is a flowchart of process steps performed by compliance and recommendation engine 404, which is included in the components of FIG. 4, in accordance with embodiments of the present invention. The process of FIG. 6 begins at a start node 600 and is followed by data reception and compliance verification in step 602, contextual analysis and supervisory control in step 604, and recommendation generation and continuous improvement in step 606. Following step 606, the process of FIG. 6 ends at an end node 608.

In sub-step 610, which is included in step 602, CRE 404 receives and verifies for compliance the processed data sent from LAE 402. CRE 404 parses the received processed data to identify key elements, including client-specific, organization-specific, and industry-specific terminologies, intents, and contexts. CRE 404 cross-references the identified key elements against organizational policies and policies about proprietary content, global standards, and industry-specific guidelines to determine a compliance with language appropriateness standards and regulatory standards.

In sub-step 612, which is included in step 604, CRE 404 analyzes the context and intent of an intended communication directed to a client by using advanced NLP and machine learning techniques provided by NLP tool 414 and machine learning models 416, respectively. Analyzing the context and the intent includes identifying and flagging the term that is non-compliant and further includes generating a terminology adjustment recommendation for replacing the identified term with an alternative term that is compliant, as discussed above.

In sub-step 614, which is included in step 604, CRE 404 determines that text is flagged as being non-compliant, and in response, CRE 404 engages supervisory control by higher authority supervisory system 418, which requires manual review and approval of the text from a higher authority. If the context and situation relative to flagged text has been previously approved for proprietary knowledge sharing, then CRE 404 does not initiate the review by higher authority supervisory system 418.

In sub-step 616, which is included in step 606, CRE 404 generates text recommendations that comply with client preferences and client-specific, organization-specific, and industry-specific terminologies.

In sub-step 618, which is included in step 606, CRE 404 learns from feedback. In sub-step 618, CRE 404 incorporates a feedback loop from communications directed to clients, responses from clients, and supervisory decisions received from higher authority supervisory system 418, as discussed above. CRE 404 uses the feedback loop to continuously refine the aforementioned analyses of terms in communications. In sub-step 618 and based on the refined analyses of terms, CRE 404 adapts recommendations for terminology adjustments in subsequent communications to evolving language trends and regulatory changes.

In the process of FIG. 6, CRE 404 can use, for example, a combination of classification algorithms (e.g., Random Forests) and deep learning models (e.g., long short-term memory (LSTM) networks) for nuanced language analysis and compliance checks. CRE 404 can perform sentiment analysis and contextual understanding using advanced NLP techniques provided by NLP tool 414.

In one embodiment, CRE 404 provides integration with enterprise-grade APIs for policy management and regulatory compliance. In one embodiment, CRE 404 adheres to data privacy regulations and secure data-handling practices, including encrypted data storage and secure API endpoints.

In one embodiment, CRE 404 provides real-time processing optimization for timely compliance checks and recommendation generation.

FIG. 7 is a flowchart of process steps performed by user interaction analyzer 406, which is included in the components of FIG. 4, in accordance with embodiments of the present invention. The process of FIG. 7 begins at a start node 700 and is followed by client profile and interaction history analysis in step 702, real-time interaction context assessment in step 704, integration of compliance and recommendation data in step 706, personalized response generation in step 708, and feedback collection and adaptive learning in step 710. Following step 710, the process of FIG. 7 ends at an end node 712.

In sub-step 714, which is included in step 702, UIA 406 determines user data by analyzing the user profile and historical interaction data of the client, which includes extracting client preferences, interaction patterns of the client, and response history relative to the client. Using this extraction and analysis, UIA 406 builds a comprehensive understanding of user data, which includes the client's communication style, client preferences, enterprise information associated with the client, terminology and technology to which the client is exposed, and past responses from the client, where the user data is used to personalize future interactions.

In sub-step 716, which is included in step 704 and is performed during an ongoing interaction with the client, UIA 406 determines and assesses the context of an intended communication in real-time. The assessment of the context includes interpreting the current conversation's terminologies, intentions, and contexts using NLP techniques provided by NLP tool 420. UIA 406 performs the assessment of the context to understand the client's immediate needs and preferences, and to ensure that the recommended text changes are contextually relevant and personalized.

In sub-step 718, which is included in step 706, UIA 406 integrates the compliance flags and text recommendation data received from the CRE 404. This integration ensures that the responses not only align with the client's preferences and interaction history, but also adhere to organizational and industry standards, and do not disclose unauthorized proprietary information.

In sub-step 720, which is included in step 708, UIA 406 uses the analyzed user data and integrated recommendations to generate a personalized response or a personalized version of the intended communication. UIA 406 generates the personalized response by selecting appropriate language and content that comply with the user profile of the client and the context of the current interaction. UIA 406 uses advanced machine learning models (i.e., machine learning models 422) to tailor responses that are both engaging and compliant. UIA 406 sends the personalized response or personalized version of the intended communication to external user interaction systems 424 for viewing by the client.

In sub-step 722, which is included in step 710 and is performed post-interaction with the client, UIA 406 collects feedback about a user's usage of the personalized version of the intended communication and the client's response to the personalized version of the intended communication after the personalized version is sent to external user interaction systems 424 for viewing by the client. UIA 406 uses this feedback, along with ongoing interactions, for adaptive learning, which includes continuously refining the personalized response generation to enhance future user interactions. The adaptive learning in sub-step 722 ensures that system 400 evolves and improves over time. For example, UIA 406 adaptively learns by determining whether recommendations are used or not, and whether recommendations are used by the user to obtain clarification and terminology alignment.

In the process of FIG. 7, UIA 406 can use, for example, machine learning techniques such as recommendation systems and predictive modeling to personalize responses. UIA 406 can employ, for example, real-time NLP algorithms for context assessment, including sentiment analysis and intent recognition.

In one embodiment, UIA 406 implements APIs for seamless data exchange with CRE 404 and other external systems. In one embodiment, UIA 406 provides compliance with data privacy standards such as General Data Protection Regulation (GDPR) for handling user data, ensuring privacy and security.

In one embodiment, UIA 406 uses architecture designed for real-time data processing, using technologies such as in-memory databases and stream-processing frameworks.

### EXAMPLES

In one example, Person J works in Sales at company XYZ. Because Person J's communication tool of choice uses the techniques disclosed herein, phrases she types that include terms her potential clients do not use are flagged for viewing by Person J, so she can change her word choice to words that the potential clients know. For instance, the system disclosed herein evaluates the customer and determines that the customer uses the term “version” instead of “snapshot” at work and provides this terminology adjustment recommendation. Person J changes the term in accordance with the recommendation and, in so doing, conveys to the client that she knows the client's business, thereby solidifying the connection between company XYZ and the client. If Person J had not changed the term, she might have lost the connection with the client and possibly the sale.

In another example, company XYZ has proprietary knowledge and often refers to projects that company XYZ are working on with code names to protect them from being revealed prematurely. Pre-announcing a product could be detrimental to sales, exposing in-development capabilities to competitors and allowing those competitors to possibly corner the market with a similar offering that is released onto the market earlier than the product of company XYZ. For example, A is communicating with a client with whom she has worked for many years. Person A is excited about a project that has not yet been announced, but could be revolutionary to her client's business. Person A excitedly messages the client, but because she uses the compliance checking features disclosed herein, her message is flagged and the Send arrow is disabled, thereby allowing her to re-think sending her message and pre-announcing the in-development project.

The descriptions of the various embodiments of the present invention have been presented herein for purposes of illustration but are not intended to be exhaustive or limited to the embodiments disclosed. Many modifications and variations will be apparent to those or ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
collecting and analyzing textual data from multiple sources to determine client-specific, organization-specific, and industry-specific terminologies, and contexts and intents associated with respective terms included in the terminologies;
identifying a term that is non-compliant with the client-specific, organization-specific, and industry-specific terminologies and the contexts and the intents by analyzing an intended communication that is directed to a client and includes the term;
determining, by a processor set, that another term is an alternative term to the identified term, and is compliant with the client-specific, organization-specific, and industry-specific terminologies and the contexts and the intents; and
flagging the identified term in real-time in the intended communication to indicate the alternative term is a recommended replacement for the identified term in the intended communication.

2. The method of claim 1, further comprising:
determining that one or more initial terms included in the intended communication are not in compliance with regulatory compliance policies or organizational policies associated with the client or includes unauthorized internal terminology or unauthorized knowledge sharing;
in response to the determining that the one or more initial terms are not in compliance with the regulatory compliance policies or organizational policies, or include the unauthorized internal terminology or the unauthorized knowledge sharing, flagging the one or more initial terms in the intended communication;
determining one or more substitute terms that are (i) replacements for the one or more terms, and (ii) in compliance with the regulatory compliance polices and the organizational policies, and do not include the unauthorized internal terminology or the unauthorized knowledge sharing; and
generating a recommendation to replace the one or more initial terms with the one or more substitute terms so that the intended communication adheres to business and regulatory guidelines.

3. The method of claim 1, further comprising:
initially identifying an initial term included in the intended communication as being not in compliance with regulatory compliance policies or organizational policies associated with the client or includes unauthorized internal terminology or unauthorized knowledge sharing;
in response to the initially identifying, initiating a supervisory control by a supervisory system;
requesting, by the supervisory system, a manual review of the one or more initial terms;
receiving, by the supervisory system, a result of the manual review indicating the initial term is in compliance with the regulatory compliance policies and the organizational policies associated with the client, and does not include the unauthorized internal terminology or the unauthorized knowledge sharing; and
in response to the receiving the result of the manual review, presenting the intended communication without flagging or replacing the initial term.

4. The method of claim 1, further comprising:
continuously analyzing previous communications with the client and feedback from the client about previous communications to identify preferences of the client;
identifying one or more terms in the intended communication that are not in compliance with the identified preferences of the client;
determining that one or more substitute terms are substitutes for the identified one or more terms, and are in compliance with the identified preferences of the client; and
flagging the identified one or more terms in the intended communication to indicate that the one or more substitute terms are recommended replacements for the identified one or more terms in the intended communication.

5. The method of claim 1, further comprising:
determining a role, an industry, an organization, a level of experience, and preferences of the client;
based on the role, the industry, the organization, the level of experience, and the preferences of the client, determining a preferred style of communication with the client;
analyzing the intended communication with the client to identify a style of the intended communication with the client as being a current style of communication;
determining that the current style of communication does not match the preferred style of communication; and
in response to the determining that the current style of communication does not match the preferred style of communication, generating a recommendation to change the style of the intended communication to the preferred style of communication.

6. The method of claim 1, wherein the collecting and analyzing the textual data includes:
ingesting, by a language analysis engine, the textual data from user and customer profiles, industry-related documents, documents about enterprise technologies, and historical conversation data;
preprocessing, by the language analysis engine, the textual data by tokenizing and normalizing the textual data, and removing characters and words from the textual data that are irrelevant to an analysis by machine learning models;
extracting, by the language analysis engine, features from the preprocessed textual data, the extracted features including (i) linguistic features that include n-grams, part-of-speech tags, and syntactic dependencies, and (ii) sematic features that include word embeddings; and
determining, by the language analysis engine, the contexts and the intents by using the extracted features and a combination of supervised and unsupervised machine learning models.

7. The method of claim 6, wherein the determining the contexts and the intents includes;
training the supervised machine learning models on labeled data sets; and
identifying the intents and the client-specific, organization-specific, and industry-specific terminologies by using the trained supervised machine learning models.

8. The method of claim 6, wherein the determining the contexts and the intents includes:
determining subjects or themes of the textual data by using the unsupervised machine learning models; and
determining a replacement term that complies with preferences of the client and industry standards based on the subjects or the themes.

9. The method of claim 6, further comprising:
continuously learning, by a learning analysis engine (LAE), based on new data;
retraining, by the LAE, the supervised machine learning models using updated data and user feedback; and
adapting, by the LAE, the supervised machine learning models to new trends in terminologies and user preferences without requiring a full retraining of the supervised machine learning models.

10. The method of claim 1, further comprising:
receiving, by a compliance and recommendation engine (CRE), data processed by a language analysis engine;
parsing, by the CRE, the received data to identify key elements, including the client-specific, organization-specific, and industry-specific terminologies, the contexts, and the intents;
cross-referencing, by the CRE, the identified key elements against organizational policies, proprietary content, global standards, and industry-specific guidelines to determine a compliance with language appropriateness standards and regulatory standards; and
analyzing, by the CRE, a context and an intent of the intended communication using natural language processing (NLP) and machine learning models, wherein the analyzing the context and the intent includes the identifying the term that is non-compliant and further includes generating a terminology adjustment recommendation for replacing the identified term with the alternative term.

11. The method of claim 10, further comprising:
continuously refining, by the CRE, analyses of terms in communications by using feedback from user interactions and decisions by a supervisory system about a compliance of given terms with regulatory compliance policies or organizational policies or about the given terms not being included in internal terminology or knowledge sharing that is unauthorized; and
adapting, by the CRE and based on the continuously refining the analyses, recommendations for terminology adjustments in subsequent communications to evolving language trends and regulatory changes.

12. The method of claim 10, further comprising:
determining, by a user interaction analyzer (UIA), user data by analyzing a user profile of the client, interaction patterns of the client, and a response history of the client, the user data including a communication style of the client, preferences of the client, enterprise information associated with an organization to which the client belongs, terminology and technology to which the client has been exposed, prior responses of the client;
determining, by the UIA, a context of the intended communication in real-time by using natural language processing to interpret terminologies, intentions, and contexts of the intended communication;
generating a personalized version of the intended communication, so that the personalized version is based on the user data, the context of the intended communication, wherein the generating the personalized version includes integrating compliance flags and recommendation data from the CRE; and
sending the personalized version of the intended communication to a user interaction system for viewing by the client.

13. The method of claim 12, further comprising:
collecting, by the UIA, feedback from (i) a usage of the terminology adjustment recommendation and the personalized version by a user, and (ii) a response by the client to the personalized version of the intended communication after the personalized version is sent to the user interaction system for viewing by the client; and
continuously refining the CRE and the UIA for subsequent terminology adjustment recommendations and subsequent personalized versions of intended communications by using the collected feedback.

14. A computer system comprising:
a processor set;
one or more computer-readable storage media; and
program instructions stored on the one or more computer-readable storage media to cause the processor set to perform computer operations comprising:
collecting and analyzing textual data from multiple sources to determine client-specific, organization-specific, and industry-specific terminologies, and contexts and intents associated with respective terms included in the terminologies;
identifying a term that is non-compliant with the client-specific, organization-specific, and industry-specific terminologies and the contexts and the intents by analyzing an intended communication that is directed to a client and includes the term;
determining that another term is an alternative term to the identified term, and is compliant with the client-specific, organization-specific, and industry-specific terminologies and the contexts and the intents; and
flagging the identified term in real-time in the intended communication to indicate the alternative term is a recommended replacement for the identified term in the intended communication.

15. The computer system of claim 14, wherein the computer operations further comprise:
determining that one or more initial terms included in the intended communication are not in compliance with regulatory compliance policies or organizational policies associated with the client or includes unauthorized internal terminology or unauthorized knowledge sharing;
in response to the determining that the one or more initial terms are not in compliance with the regulatory compliance policies or organizational policies, or include the unauthorized internal terminology or the unauthorized knowledge sharing, flagging the one or more initial terms in the intended communication;
determining one or more substitute terms that are (i) replacements for the one or more terms, and (ii) in compliance with the regulatory compliance polices and the organizational policies, and do not include the unauthorized internal terminology or the unauthorized knowledge sharing; and
generating a recommendation to replace the one or more initial terms with the one or more substitute terms so that the intended communication adheres to business and regulatory guidelines.

16. The computer system of claim 14, wherein the computer operations further comprise:
initially identifying an initial term included in the intended communication as being not in compliance with regulatory compliance policies or organizational policies associated with the client or includes unauthorized internal terminology or unauthorized knowledge sharing;
in response to the initially identifying, initiating a supervisory control by a supervisory system;
requesting, by the supervisory system, a manual review of the one or more initial terms;
receiving, by the supervisory system, a result of the manual review indicating the initial term is in compliance with the regulatory compliance policies and the organizational policies associated with the client, and does not include the unauthorized internal terminology or the unauthorized knowledge sharing; and
in response to the receiving the result of the manual review, presenting the intended communication without flagging or replacing the initial term.

17. The computer system of claim 14, wherein the computer operations further comprise:
continuously analyzing previous communications with the client and feedback from the client about previous communications to identify preferences of the client;
identifying one or more terms in the intended communication that are not in compliance with the identified preferences of the client;
determining that one or more substitute terms are substitutes for the identified one or more terms, and are in compliance with the identified preferences of the client; and
flagging the identified one or more terms in the intended communication to indicate that the one or more substitute terms are recommended replacements for the identified one or more terms in the intended communication.

18. The computer system of claim 14, wherein the computer operations further comprise:
determining a role, an industry, an organization, a level of experience, and preferences of the client;
based on the role, the industry, the organization, the level of experience, and the preferences of the client, determining a preferred style of communication with the client;
analyzing the intended communication with the client to identify a style of the intended communication with the client as being a current style of communication;
determining that the current style of communication does not match the preferred style of communication; and
in response to the determining that the current style of communication does not match the preferred style of communication, generating a recommendation to change the style of the intended communication to the preferred style of communication.

19. The computer system of claim 14, wherein the collecting and analyzing the textual data includes:
ingesting, by a language analysis engine, the textual data from user and customer profiles, industry-related documents, documents about enterprise technologies, and historical conversation data;
preprocessing, by the language analysis engine, the textual data by tokenizing and normalizing the textual data, and removing characters and words from the textual data that are irrelevant to an analysis by machine learning models;
extracting, by the language analysis engine, features from the preprocessed textual data, the extracted features including (i) linguistic features that include n-grams, part-of-speech tags, and syntactic dependencies, and (ii) sematic features that include word embeddings; and
determining, by the language analysis engine, the contexts and the intents by using the extracted features and a combination of supervised and unsupervised machine learning models.

20. A computer program product comprising:
one or more computer-readable storage media; and
program instructions stored on the one or more computer-readable storage media to perform computer operations comprising:
collecting and analyzing textual data from multiple sources to determine client-specific, organization-specific, and industry-specific terminologies, and contexts and intents associated with respective terms included in the terminologies;
identifying a term that is non-compliant with the client-specific, organization-specific, and industry-specific terminologies and the contexts and the intents by analyzing an intended communication that is directed to a client and includes the term;
determining that another term is an alternative term to the identified term, and is compliant with the client-specific, organization-specific, and industry-specific terminologies and the contexts and the intents; and
flagging the identified term in real-time in the intended communication to indicate the alternative term is a recommended replacement for the identified term in the intended communication.
